(19) United States
(12) Patent Application Publication
(10) Pub. No.: US 2004/0241531 A1
(43) Pub. Date: Dec. 2, 2004

(54) Membrane-electrode assembly for a self-humidifying fuel cell

(76) Inventors: Hubertus Biegert, Unterkirnach (DE); Gabor Toth, Illertissen-Jedesheim (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/489,943

(22) PCT Filed: Sep. 14, 2002
(86) PCT No.: PCT/EP02/10328

(30) Foreign Application Priority Data
Sep. 18, 2001 (DE) 101 45 875.4

(51) Int. Cl. H01M 4/96

(52) U.S. Cl. 429/44; 429/41

(57) ABSTRACT

The invention relates to a membrane-electrode assembly for a self-humidifying fuel cell. The electrodes of the MEA according to the invention consist of a catalyst layer applied on the membrane side, of a microporous electrode layer adjacent thereto and of a macroporous electrode layer disposed thereupon, the microporous electrode layer exhibiting lamellar graphite on the cathode side and, on the anode side, particles of carbon black having a rough surface and having the capacity for storing water. By reason of the structure and the morphology of the respective electrode, by reason of the interaction of the two electrodes in the MEA composite and their coordination with one another, a mass flow from the cathode to the anode develops which favours the back-diffusion of the reaction water through the electrolyte and consequently guarantees an adequate humidification of the electrolyte.

The invention relates to a membrane-electrode assembly (MEA) for a self-humidifying fuel cell.

Known from DE 199 21 007 C1 is a fuel cell with membrane-electrode assemblies and with gas ducts integrated within the bipolar plates for the humidification of a membrane by some of the product water arising in operation of the fuel cell being fed back to the gas inlet by capillary forces. For the purpose of transporting the liquid in this case, both the bottom of the duct and the walls of the duct may be provided with a capillary layer.

A gas-diffusion electrode having reduced diffusivity in respect of water and a process for operating a PEM fuel cell without supply of membrane-humidification water are known from DE 197 09 199 A1. This is achieved through a modification of the gas-diffusion electrodes by press-moulding at high pressures from 200 bar to 4000 bar, by sealing of the electrode material against losses of water by means of filling material or by the application of a further layer on the surface of the electrode.

Polymer-electrolyte-membrane (PEM) fuel cells always require for the proton-conducting mechanism a very thorough humidification of the electrolyte. Without adequate humidification, the power of the fuel cell declines. In the most unfavourable case, the drying-out of the electrolyte may result in crashing of the fuel cell. For this reason, fuel-cell systems that are intended to have a very high power density are constructed with additional, external gas humidifiers. Since, likewise for reasons of increasing the power, fuel cells are ideally operated at temperatures of at least 70° C., better at temperatures higher than 80° C., as a rule these systems work at an operating pressure of at least 2.5 bar, in order to prevent excessive drying-out of the fuel cell. On the other hand, a fuel-cell system that could make do without additional, external humidification would represent a significant simplification of the system. A reduction of the working pressure would also make the system simpler and would increase the efficiency of the system.

The object of the invention is therefore to make available a membrane-electrode assembly that is capable of guaranteeing an adequate humidification of the electrolyte under these operating conditions without external humidification, without impeding the provisioning of the reaction layers with the gases.

This object is achieved by virtue of the characterising features of claim 1. The dependent claims relate to advantageous configurations of the invention.

Advantageously, by reason of the structure and the morphology of the respective electrode, by reason of the interaction of the two electrodes in the MEA composite and their coordination with one another, a mass flow from the cathode to the anode may develop which favours the back-diffusion of the reaction water through the electrolyte and consequently guarantees an adequate humidification of the electrolyte. As a further advantage, fuel-cell systems that contain the MEA according to the invention can be operated at reduced working pressure, as a result of which the system can be distinctly simplified structurally and the efficiency can be increased.

The invention will be elucidated in more detail below with reference to the Figures. Shown are:

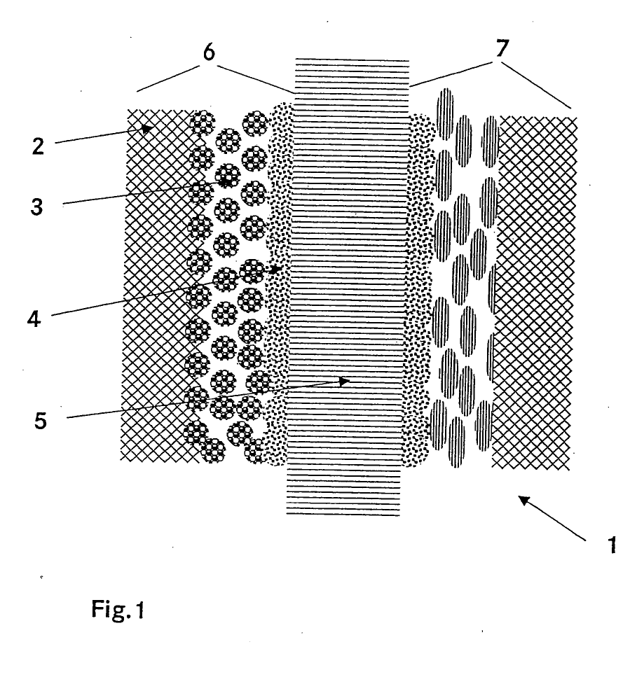

FIG. 1 in exemplary manner, a schematic representation of an MEA structure

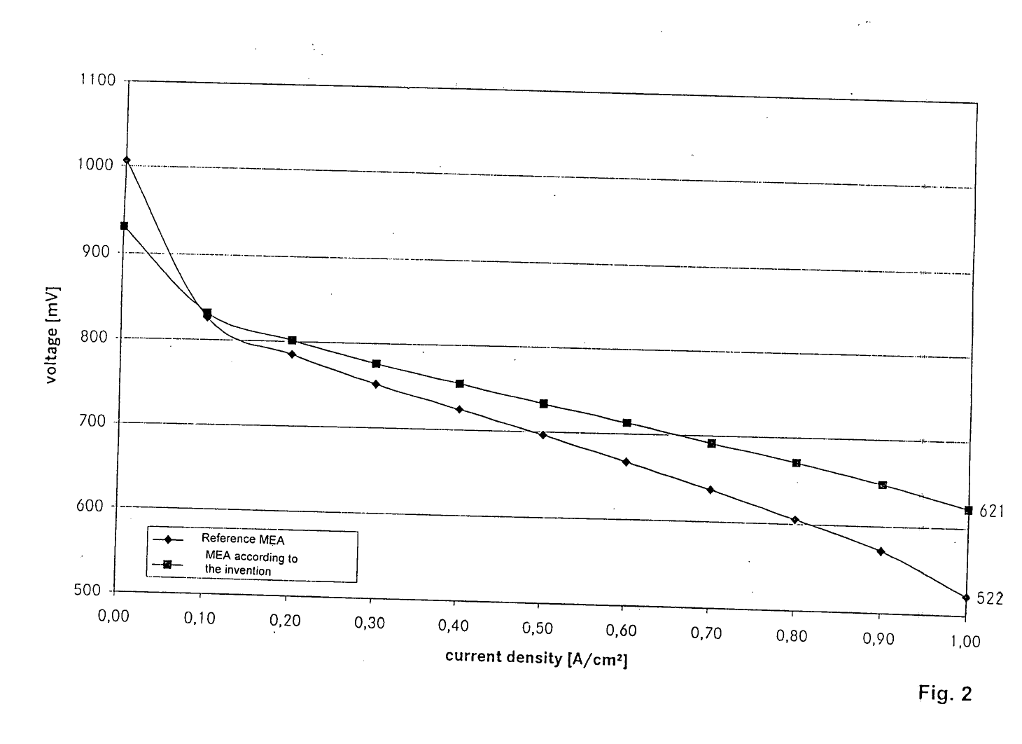

FIG. 2 as an example, a comparison of two current/voltage characteristics, namely that of an MEA according to the invention with that of a reference MEA

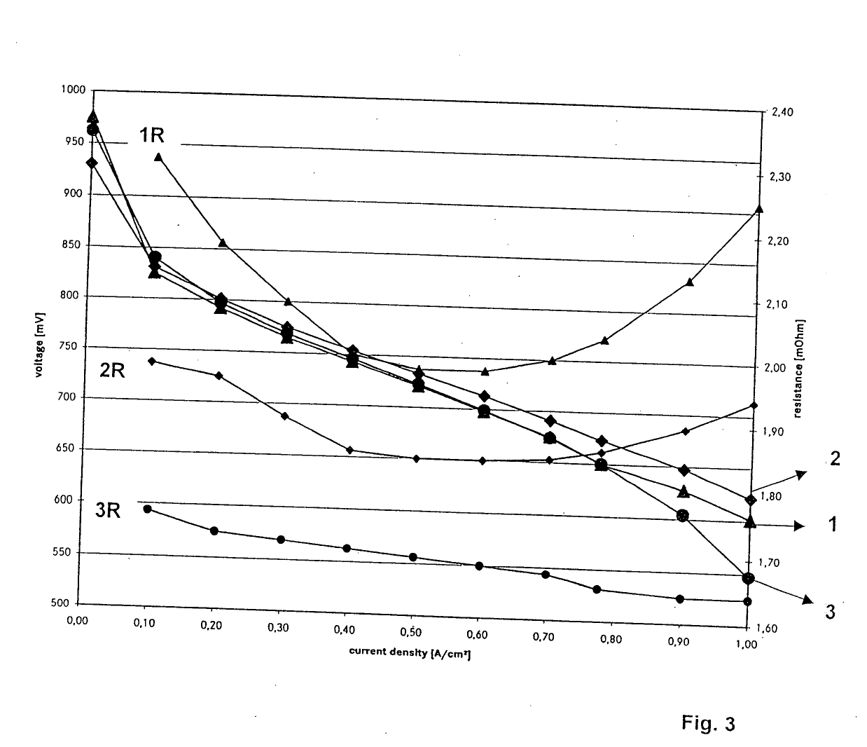

FIG. 3 the influence of the degree of loading of the anode on the performance of an MEA according to the invention

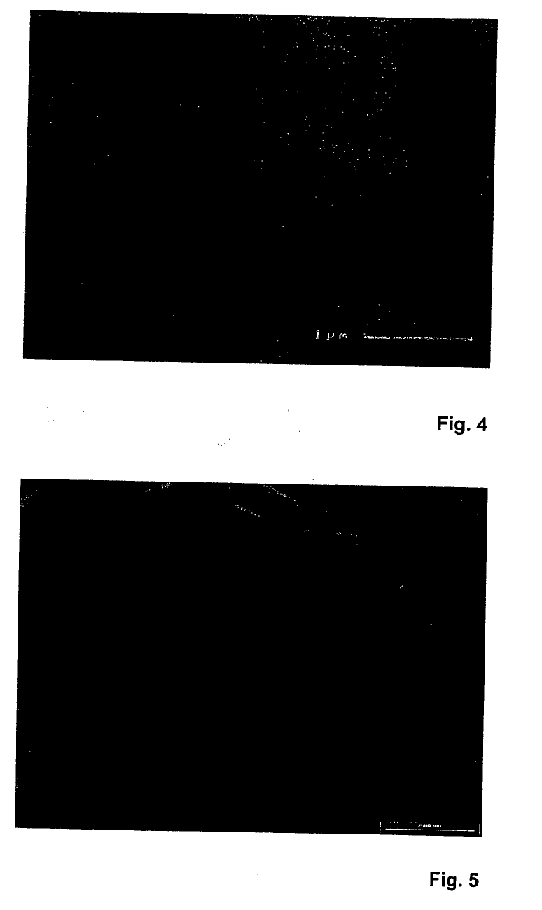

FIG. 4 an SEM photograph of a carbon black which is used as a possible variant on the anode side of the MEA according to the invention

FIG. 5 an SEM photograph of a graphite which is used as a possible variant on the cathode side of the MEA according to the invention

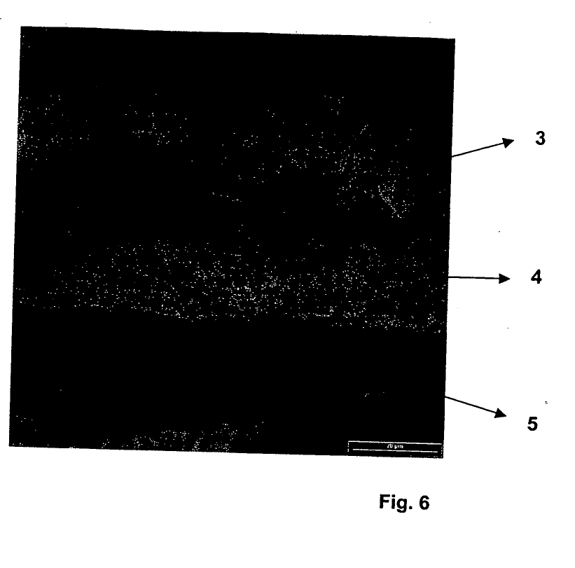

FIG. 6 an SEM photograph of an MEA according to the invention with lamellar graphite on the cathode side

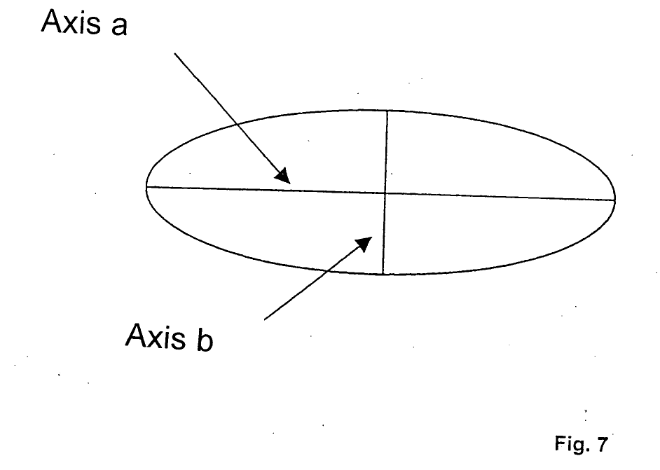

FIG. 7 a schematic representation of the axial ratio of a lamellar graphite particle

In order that fuel cells can be operated efficiently at low operating pressures and at temperatures of at least 70° C., the water required for the proton-conducting mechanism can only be made available from the cathodic reaction. In conventional fuel cells, however, the gas streams within the cell are able to take up and discharge more water than arises as a result of the cathodic reaction. This results ultimately in a negative water balance of the fuel cell. With a view to solving this problem, according to the invention a membrane-electrode assembly having self-humidifying properties is made available. The term ‘self-humidifying’ means that water that leaves the cell through the stream of cathodic waste gas or that leaves the anode through the stream of reactant gas has to be balanced out by water that is produced electrochemically at the cathode and retained within the cell, in order to guarantee an adequate humidification of the electrolyte.

It is proposed to redirect the water arising as a result of the cathodic reaction in the MEA by virtue of a suitable structure of the fuel-cell electrodes, by virtue of the structural features of the individual layers, in particular also of the microporous layers, and by virtue of the coordination of anode and cathode with one another with respect to the microporous layer, in such a way that said water is substantially available for the purpose of humidifying the electrolyte without simultaneously impeding the provisioning of the electrodes with the reaction gases. To this end, the anode and cathode are designed in such a way that the reaction water arising on the cathode side is, in a sufficiently high proportion, not transported away via the cathode compartment but, in particularly advantageous manner, gets back into the electrolyte as a result of back-diffusion.

As represented in FIG. 1, the membrane-electrode assembly 1 according to the invention for a fuel cell comprises an anode 6, a cathode 7 and a polymer-electrolyte membrane 5 arranged in between, the electrodes 6, 7 consisting of a catalyst layer 4 applied on the membrane side, of a microporous electrode layer 3 adjacent -thereto and of a macroporous electrode layer 2 disposed thereupon, the microporous electrode layer 3 exhibiting lamellar graphite on the cathode side and, on the anode side, particles of carbon black having a rough surface and having the capacity for storing water, and the degree of loading with carbon on the cathode side covering a range between about 0.5 mg/cm² and 6 mg/cm² and, on the anode side, a range between about 0.2 mg/cm² and 4 mg/cm². The degree of loading with carbon may be less on the anode side than on the cathode side. The degree of loading of the microporous layer 3 depends greatly on the carbon that is being used. The statement on the degree of loading corresponds to a weight per unit area.

The macroporous layer 2 or lamination serves, on the one hand, as a spacer above the structure of the gas-distribution duct, also known as a flow field or bipolar plate, on the other hand substantially for distribution of the reaction gases. The bipolar plate has not been drawn in the schematic drawing. Provisioning of the reaction layers 4 with the gases, preferably H₂ and O₂ or air, is effected via the equalisation of the concentration in the electrode compartment and in the flow-field compartment.

As a result of interaction between the cathode 7 and the anode 6 within the MEA 1, a mass flow from the cathode to the anode develops which guarantees an adequate humidification of the electrolyte 5.

The cathode 7 therefore takes the form of a vapour diffusion barrier, without impeding the inward transportation of the air or of the oxygen. This is obtained by virtue of morphological measures in the microporous gas-distribution lamination 3 and by virtue of the composition thereof. The water-retaining capacity is assisted by the reduction of mass-transfer processes. In particular, the microporous cathodic layer 3 here acts as a water-vapour diffusion barrier. For this purpose, the cathode 7 is designed in such a way that the reaction water arising cannot be fixed by capillary forces—or can be fixed only in a small proportion—in the microporous layer 3 situated above the preferably hydrophobic reaction layer 4. Compared with the anode side, the microporous electrode layer 3 exhibits no storage of water, or only a very low storage of water. The distance that the water covers until it enters the free flow-field gas stream can be increased on the one hand by increasing the loading, on the other hand by virtue of morphological measures with respect to the material that itself constitutes the layer 3. The mass transfer in the boundary region between the free gas stream and the microporous layer 3 is lowered by the reduction of the microturbulences. The hydrophobizing of this layer and the ratio of fine material to coarse material within the grain-size distribution in this lamination have to be chosen so that the provisioning of the catalyst layer 4 with oxygen is not prevented. If the proportion of fine material is too high, the gas ducts become clogged.

The cathode 7 is constructed from a macroporous backing layer 2 which contains a paper, fleece or similar made of carbon, for example the carbon paper TGP H090 manufactured by Toray, which is provided with a microporous, preferably textured, carbon layer 3. The carbon particles of the microporous layer 3 should be such that they are unable to store water, or are able to store only very little water, and exhibit a BET specific surface area of approximately 60 m²/g to 100 m²/g or a particle size from about 20 nm to 100 nm. This can be effected by a granulation of the carbon with suitable additives. However, use is preferably made of graphitic carbon. The mean grain size (D50 value) in this case is between about 0.5 μm and 10 μm , preferably between about 2 μm and 6 μm. The BET specific surface area is established within a range from about 5 m²/g to 30 m²/g, preferably at about 20 m²/g. As a result of a plate-like formation of the carbon, a texturing, i.e. a substantially horizontal arrangement of the graphite agglomerates which are composed of individual lamellar primary particles, can be obtained. The microporous electrode layer 3 therefore exhibits lamellar graphite on the cathode side, the axial ratio, as represented in FIG. 7, of the lamellar graphite being between 3 and 12, preferably between 3 and 6. The graphite lamellae exhibit, in addition, a smooth surface, which reduces the microturbulences, i.e. the formation of a turbulent flow which would favour the mass transfer perpendicular to the gas stream, and consequently impairs the mass transfer, i.e. the absorption of water within the layer. The water-retaining capacity is therefore assisted by the reduction of mass-transfer processes. The texturing acts additionally on the path-length of the water from the reaction front until it reaches the free stream of cathodic (waste) gas. The arrangement of the lamellar graphite is largely parallel to the membrane 5. The microporous electrode layer 3 of the cathode 7 may, in addition, be made hydrophobic, in which case a fluorinated polymer, preferably PTFE, finds application. The content of PTFE in the layer is between about 0% and 20% by weight, preferably between about 5% and 15% by weight, particularly preferably about 11% by weight. The macroporous electrode layer 2 is preferably not made hydrophobic.

By way of polymeric material for the anode 6 and the cathode 7, polymer electrolytes 5 based on Nafion manufactured by DuPont may find application, but also membranes based on at least one polymer containing perfluorosulfonic acid, on a fluorinated polymer containing sulfonic-acid groups, on a polymer based on polysulfones or polysulfone modifications, for example PES or PSU, on a polymer based on aromatic polyether ketones, for example PEEK, PEK or PEEKK, on a polymer based on trifluorostyrene, as described, for example, in WO 97/25369 held by Ballard, or based on a composite membrane as set forth as an example in an older, previously unpublished document DE 199 43 244 originating from DaimlerChrysler, in WO 97/25369 or WO 90/06337 held by Gore/DuPont de Nemours.

The anode 6 is formed in such a way that it favours the back-diffusion of the reaction water through the electrolyte 5. The provisioning of the anodic reaction front with hydrogen is not impeded thereby. The anode 6 appropriate thereto must therefore be designed in such a way that it displays an appropriate water-absorbing capacity and that the free path-length of the water until it enters the stream of hydrogen gas is chosen so that the anode is not flooded. As a result of the absorption of water, a water-concentration gradient arises which readily dehydrates the electrolyte 5 and in this way triggers a mass flux from the cathode 7 to the anode. This is achieved by combining suitable materials. The morphological properties and the loading of the microporous layer 3 are also crucial here. Mass transfer within the fuel cell is generally effected via two mechanisms: inward and outward transportation of the water is effected, on the one hand, with the gas stream which extends parallel to the surface of the electrode, on the other hand by the concentration equalisation, oriented perpendicular thereto, by virtue of the diffusion of the water through the porous layers to or from the reaction zone. Since, especially with a view to a low pressure level in the flow field, the streams of gas are, as a rule, more likely to be laminar, here the mass transfer in the direction extending perpendicular to the stream is rather poor. This changes in the region of the porous layers. Here microturbulences are generated which favour the mass transfer and therefore the release and absorption of water. The microporous electrode layer 3 of the anode 6 is composed of carbon agglomerates which have various structural planes. The carbon black consists of very small, approximately spherical primary particles with a defined porosity, which form clusters that the agglomerates are composed of. A microscopic capillary structure and a macroscopic capillary structure are formed, which are capable of storing water in themselves by capillary condensation, and also of retaining said water, within certain limits, with the aid of capillary forces. By hydrophobizing of this layer, the storage can be influenced further. Adjacent layers or regions may be humidified or dehumidified in this way. The microporous electrode layer 3 of the anode 6 may additionally be made hydrophobic, in which case a fluorinated polymer, preferably PTFE, finds application. The macroporous electrode layer 2 is preferably not made hydrophobic. The content of PTFE in the layer amounts to between about 0% and 20% by weight, preferably between about 5% and 15% by weight, particularly preferably about 11% by weight. The anode takes the form of a dehydration layer.

Production of the MEA is effected, for example, by processes such as are described in the still unpublished patent applications DE 100 52 224 or DE 100 52 190, or in accordance with another process that is customary in the state of the art and suitable for producing the MEA. In order to assemble the electrodes 6, 7 with the polymer-electrode membrane so as to form a membrane-electrode assembly 1, a pressure is employed within the range from about 300 N/cm² to 350 N/cm². In this case the material is not compressed.

Shown in exemplary manner in FIG. 2 is the comparison of two current/voltage characteristics, namely that of a membrane-electrode assembly according to the invention and that of a reference MEA. By way of layer 2 on the anode side and on the cathode side, both MEAs exhibit a carbon paper manufactured by Toray, TGP H090; platinum is used as catalyst material; the degree of loading of the catalyst amounts to about 4 mg/cm²; a Nafion membrane 112 manufactured by Dupont de Nemours was employed as membrane material. By way of layer 3 on the cathode side, the MEA according to the invention exhibits graphitic, lamellar carbon, for example the product Timrex KS6 manufactured by Timcal, with a degree of loading between about 1.5 mg/cm² and 3 mg/cm² and with a mean grain size within the range from about 3 μm to 4 μm; on the cathode side, the reference MEA exhibits particles of carbon black (e.g. Acetylen Black C50 manufactured by Chevron) with a degree of loading between about 0.9 mg/cm² and 2 mg/cm². The counter-electrode (here, the anode) for the MEA according to the invention corresponds to the structure of the anode of the reference MEA. In the microporous layer 3 the anode contains particles of carbon black (e.g. Acetylen Black C50 manufactured by Chevron) with a degree of loading between 0.4 mg/cm² and 4 mg/cm². On the cathode side and on the anode side, the microporous layer 3 exhibits a PTFE content of approximately 11% by weight. The measurement of these MEAs was carried out in a hydrogen/air-operated fuel cell, the stoichiometric proportion of H₂/air amounting to 1.2/1.5, and the temperature of the cell amounting to about 73° C. The absolute pressure on the anode side and on the cathode side amounts in this example to 1.5 bar. In the low-pressure range the MEA according to the invention displays improved performance in comparison with the reference MEA.

The influence of the degree of loading of the anode on the performance of an MEA according to the invention is represented in FIG. 3. The degree of loading of the anode (substantially the weight per unit area of the microporous electrode layer 3 consisting of particles of carbon black) rises in value from sample 1 to sample 3. The degree of loading of the cathode (substantially the weight per unit area of the microporous electrode layer 3 consisting of lamellar graphite) is kept constant. Platinum is used as catalyst material; the degree of loading of the catalyst amounts to about 4 mg/cm². The measurement of these MEAs was carried out in a hydrogen/air-operated fuel cell, the stoichiometric proportion of H₂/air amounting to about 1.2/1.5, and the temperature of the cell amounting to approximately 70° C. The temperature of the reformate gas H₂ amounts to approximately 65° C. The absolute pressure on the anode side and on the cathode side in this example is about 1.5 bar.

The curves 1 to 3 labelled with R indicate the resistance behaviour of the samples during the measurement; the curves labelled with a single numeral indicate the current/voltage characteristic of the respective samples 1 to 3.

As is evident from the diagram, sample 1 shows a drop in voltage and a considerable rise in resistance. The electrolyte dries out; the sample is consequently loaded too low. In the case of sample 2, the resistance behaviour permits an equalised water balance to be inferred; the loading of sample 2 is consequently good. Sample 3 permits a drop in voltage and also in resistance to be discerned. The resistance behaviour shows clearly that the anode is too highly loaded and is therefore flooded. As becomes clear from this experiment, on the one hand the structure and the morphology of the respective electrode, but also the interaction of the two electrodes in the MEA composite and consequently their coordination with one another, are crucial for the performance of a fuel cell, in order that a mass flow from the cathode to the anode can develop which favours the back-diffusion of the reaction water through the electrolyte and consequently guarantees an adequate humidification of the electrolyte.

FIG. 4 shows an SEM photograph of carbon-black particles which, for example, can be employed in the microporous layer 3 on the anode side of the MEA according to the invention. Here, for example, carbon black manufactured by Chevron, Acetylen Black C50, may find application. The density of the carbon black lies within the range from about 0.09 g/cm³ to 0.11 g/cm³; the particle size is about 300 nm.

FIG. 5, on the other hand, shows an SEM photograph of a lamellar graphite which, for example, can be employed in the microporous layer 3 on the cathode side of the MEA according to the invention. The graphite, which is shown in exemplary manner, exhibits a BET specific surface area of about 20 m²/g, a D50 value of about 3.4 μm and a D90 value of about 6 μm. Here, for example, graphite manufactured by Timcal, Timrex KS6, may find application. FIG. 6 represents a detail from an MEA according to the invention with lamellar graphite in the microporous layer 3 on the cathode side, with a catalyst layer 4 adjacent thereto and with the electrolyte 5 subsequent thereto. The macroporous electrode layer 2 is not represented.

1. A membrane-electrode assembly (1) for a fuel cell, comprising an anode (6), a cathode (7) and a polymer-electrode membrane (5) arranged in between, characterised in that
the electrodes (6, 7) consist of a catalyst layer (4) applied on the membrane side, of a microporous electrode layer (3) adjacent thereto and of a macroporous electrode layer (2) disposed thereupon, the microporous electrode layer (3) exhibiting lamellar graphite on the cathode side and, on the anode side, particles of carbon black having a rough surface and having the capacity for storing water, the degree of loading with carbon on the cathode side covering a range between about 0.5 mg/cm² and 6 mg/cm² and, on the anode side, a range between about 0.2 mg/cm² and 4 mg/cm².

2. Membrane-electrode assembly according to claim 1, characterised in that
the degree of loading with carbon on the anode side is less than on the cathode side.

3. Membrane-electrode assembly according to claim 1, characterised in that
the axial ratio of the lamellar graphite is between 3 and 12.

4. Membrane-electrode assembly according to claim 1, characterised in that
the particles of carbon black exhibit a density from about 0.05 g/cm³ to about 0.2 g/cm³ and a particle size from about 200 nm to 600 nm.

5. Membrane-electrode assembly according to claim 1, characterised in that
the microporous electrode layer (3) on the cathode side exhibits no capacity for storing water or only a low capacity for storing water compared with the anode side.

6. Membrane-electrode assembly according to claims 1 to 5, characterised in that
the anode (6) takes the form of a dehydration layer.

7. Membrane-electrode assembly according to claim 1, characterised in that
the microporous electrode layer (3) is made hydrophobic both on the anode side and on the cathode side.

8. Membrane-electrode assembly according to claim 1, characterised in that
the catalyst layer (4) is made hydrophobic.
